(19) United States
(12) Patent Application Publication
(10) Pub. No.: US 2017/0024097 A1
(43) Pub. Date: Jan. 26, 2017

(54) Method and Host Server for Creating a Composite Media File

(71) Applicant: Bravo Ideas Digital Co., Ltd., Tortola (VG)

(72) Inventor: Yi-Chih Lu, Taipei City (TW)

(21) Appl. No.: 15/286,982

(22) Filed: Oct. 6, 2016

Related U.S. Application Data
(63) Continuation-in-part of application No. 14/022,391, filed on Sep. 10, 2013, now abandoned.

(30) Foreign Application Priority Data
Sep. 13, 2012 (TW) 101133426

(51) Int. Cl. G06F 3/0484; H04N 21/431; H04N 21/478; G06Q 30/02; H04N 21/81; H04N 21/44; H04N 21/2743; G06F 17/22; H04N 21/485

(52) U.S. Cl. CPC G06F 3/0484; G06F 17/2235; H04N 21/4316; H04N 21/47815; H04N 21/4858; H04N 21/812; H04N 21/44016; H04N 21/2743; G06Q 30/0241; G06F 3/04842

(57) ABSTRACT

A method for creating a composite media file includes: receiving a first command directed to a primary media file; retrieving the primary media file based on the first command; receiving a second command directed to a secondary media file, the second command including at least one designated time instance associated with the primary media file; retrieving the secondary media file based on the second command; and creating a composite media file that incorporates the primary media file and the secondary media file. The composite media file is created in such a manner that when played, the secondary media file is displayed simultaneously with and separately with respect to the primary media file at the designated time instance.

### CROSS-REFERENCE TO RELATED APPLICATION

This application is a continuation-in-part of U.S. patent application Ser. No. 14/022,391 filed on Sep. 10, 2013, which claims priority to Taiwanese Application No. 101133426, filed on Sep. 13, 2012, the contents of which are hereby incorporated by reference in their entirety.

### BACKGROUND OF THE INVENTION

Field of the Invention

The invention relates to a method and a host server for creating a composite media file.

Description of the Related Art

Online video-sharing is a representative application of Web 2.0. A variety of user-generated videos, such as movie trailer, home videos, etc., may be watched online by people all over the world through video-sharing websites.

Because of such characteristics, companies may promote their products through popular video-sharing websites instead of paying a lot of money for promotion through traditional media.

Referring to FIG. 1, a conventional advertising model is shown to display a banner ad 92 at the bottom of a player screen that displays a video 91 selected by a user. However, the banner ad 92 is usually irrelevant to the video 91 and covers a portion of the video 91 (e.g., subtitle). The user may need to manually close the banner ad 92, thereby adversely affecting viewing experience. Advertisements should be made to excite people's interests to purchase products, but the aforementioned advertising model may be ineffective since the user may close the banner ad 92 immediately to continue watching the video 91.

Another conventional advertising model is to provide an advertising video using the player before reproduction of the video selected by the user. Although the advertising video cannot be skipped, the user may choose to do something else during playback of the advertising video, and the expected advertising effect cannot be achieved.

The abovementioned advertising models are ineffective in attracting user's interests since the advertisement is usually irrelevant to the video that is to be viewed by the user, and has a negative impact on the viewing experience.

### SUMMARY OF THE INVENTION

Therefore, an object of the present invention is to provide a method for creating a composite media content that may overcome the above drawbacks of the prior art.

According to one embodiment of the disclosure, the method is implemented by a processor included in a host server. The method includes the steps of:

generating an interface and presenting the interface to a client electronic device that communicates with the host server;

receiving a first command directed to a primary media file via the interface, the primary media file being a video file;

retrieving the primary media file based on the first command;

receiving a second command directed to a secondary media file via the interface, the second command including at least one designated time instance associated with playing of the primary media file;

retrieving the secondary media file based on the second command; and

creating a composite media file that incorporates the primary media file and the secondary media file.

The processor is programmed to create the composite media file in such a manner that when the composite media file is played by a media playing device, the secondary media file is displayed simultaneously with and separately with respect to the primary media file on a screen of the media playing device at the designated time instance.

Another object of the disclosure is to provide a host server that is capable of implementing the above-mentioned method.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a conventional advertising model used in a video-sharing website;

FIG. 2 is a schematic diagram illustrating relationships between devices involved in a method implemented by a publishing system according to the present invention;

FIG. 3 is a block diagram illustrating a preferred embodiment of the publishing system according to the present invention;

FIG. 4 is a schematic diagram showing an electronic setup page provided to an editing electronic device;

FIG. 5 is a flow chart illustrating steps of a method for preparation of composite media content according to the present invention;

FIG. 6 is a flow chart illustrating steps of a method for publishing the composite media content that is interactive;

FIG. 7 is a schematic diagram illustrating reproduction of the composite media content;

FIG. 8 is a block diagram illustrating a host server for implementing a method for creating a composite media file, according to one embodiment of the disclosure;

FIG. 9 is a flow chart illustrating steps of the method for creating the composite media file according to one embodiment of the disclosure;

FIGS. 10A and 10B illustrate exemplary first instruction pages that instruct the user to provide a first command directed to a primary media file;

FIG. 11 illustrates a video provided to serve as the primary media file;

FIG. 12 illustrates an exemplary information page;

FIG. 13A illustrates an exemplary second instruction page;

FIG. 13B illustrates setting of a designated enter time instance and a designated exit time instance;

FIG. 14A illustrates a preview page of the completed composite media file;

FIG. 14B illustrates the completed composite media file being uploaded onto a video sharing site and being embedded into a website; and

FIG. 15 illustrates an image showing a ring being selected and a corresponding button being clicked, triggering opening of a predefined webpage.

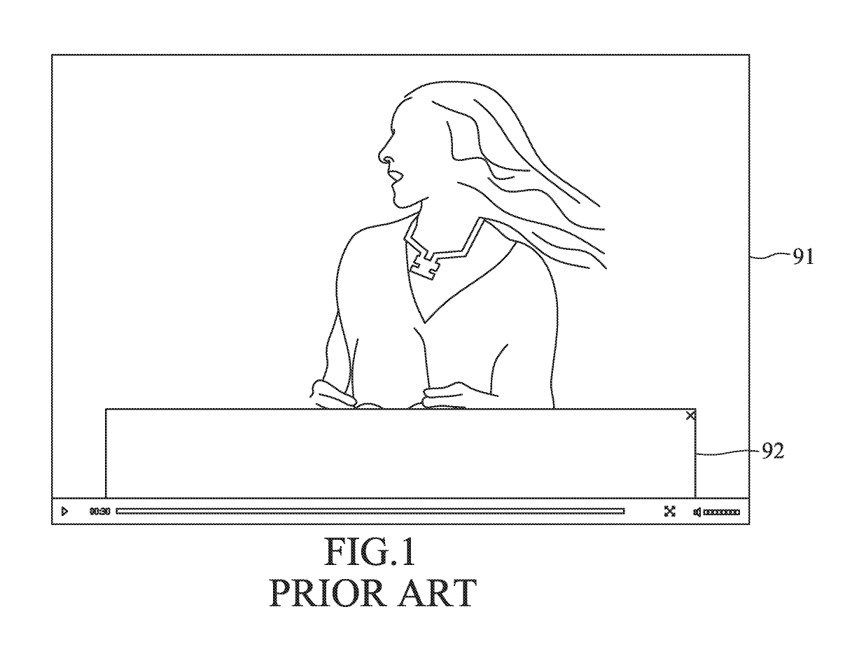

### DETAILED DESCRIPTION OF THE EMBODIMENT

Before the disclosure is described in greater detail, it should be noted that where considered appropriate, reference numerals or terminal portions of reference numerals have been repeated among the figures to indicate corresponding or analogous elements, which may optionally have similar characteristics.

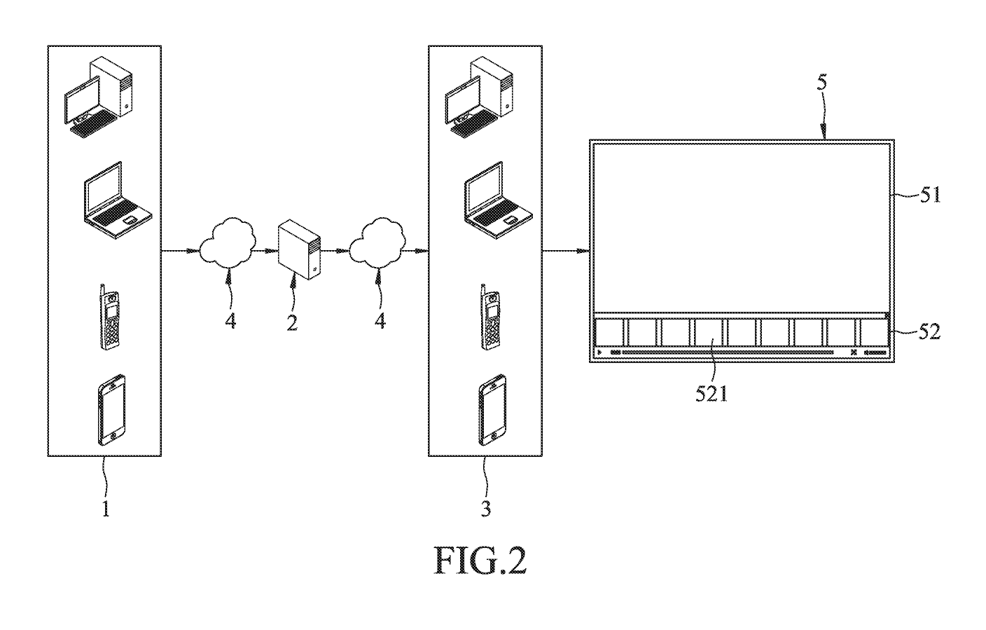

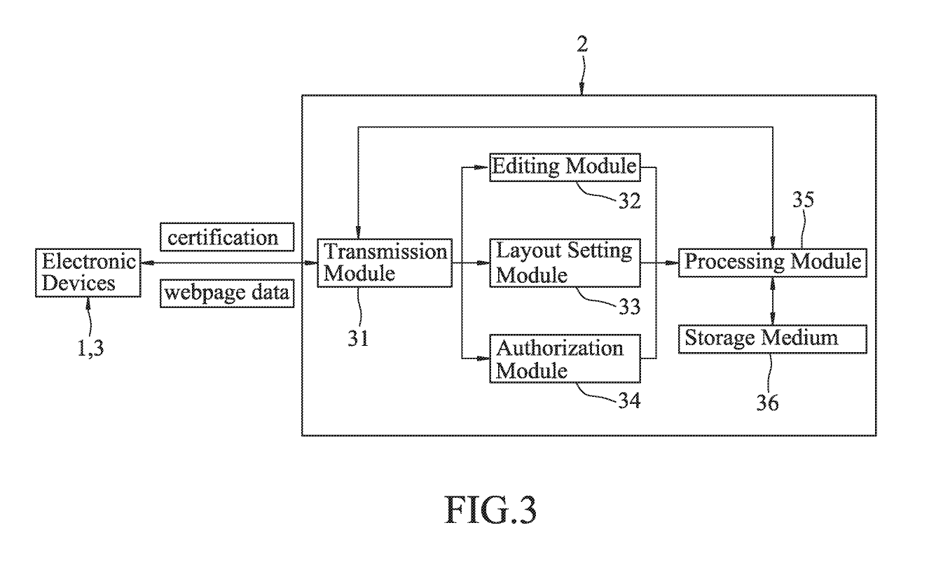

Referring to FIG. 2, one embodiment of the publishing system for publishing composite media content 5 according to this invention is shown to be implemented using cloud computing that involves an editing electronic device 1, a server 2, and a client electronic device 3 that communicate with each other through a network 4. The composite media content 5 includes primary media content 51 and secondary media content 52. In this embodiment, the secondary media content 52 is media advertising content having a predefined correspondence with the primary media content 51. Each of the editing electronic device 1 and the client electronic device 3 may be a computer device such as a notebook computer, a tablet computer or a touch computer, or a portable communication device such as a smartphone or a personal digital assistant device. The network 4 may be either internet or intranet. Referring to FIG. 3, in this embodiment, the publishing system is the server 2 that includes a transmission module 31, an editing module 32, a layout setting module 33, an authorization module 34, a processing module 35 and a storage medium 36 accessible to the publishing system.

The transmission module 31 is used for data transmission with the editing electronic device 1 and the client electronic device 3 via the network 4. In this embodiment, the transmission module 31 utilizes web socket techniques, such as Extensible Markup Language (XML), Personal Home Page (PHP) tools, or active server pages (ASP or ASP.NET), to provide an electronic setup page generated by the publishing system to the editing electronic devices 1 for input of setup data by a content provider, and to provide webpage data generated by the publishing system to the client electronic device 3 for presentation of the composite media content 5. The primary media content 51 may be sourced from a primary media content item, which may be a local motion video file or a motion video accessible via a website link. The secondary media content 52 may be sourced from one or multiple secondary media content items including a still image, a motion image, a webpage, a text or combinations thereof.

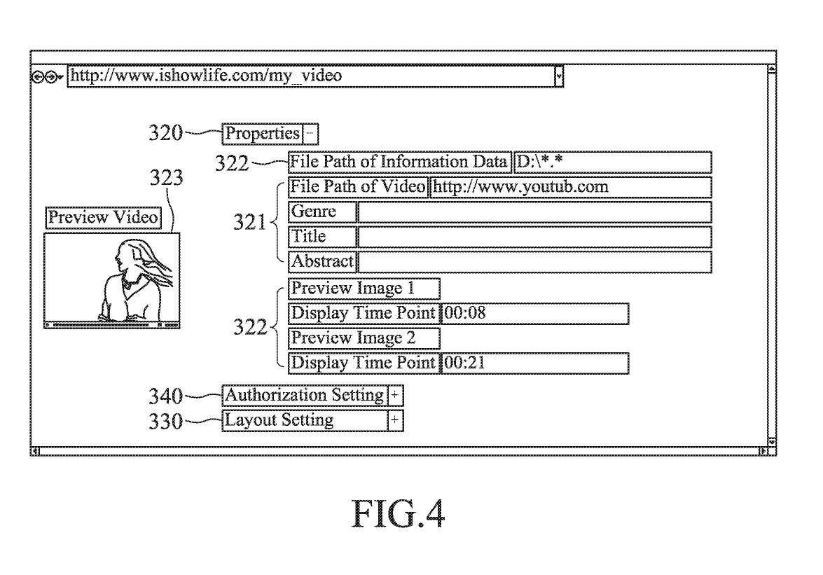

FIG. 4 is schematic diagram showing the electronic setup page. The editing module 32 sets properties of the composite media content 5 according to the setup data inputted in an editable property field set 320 of the electronic setup page. The property field set 320 includes at least a file path of the primary media content item, and information of the secondary media content items. The file path of the primary media content item is directed to a file location in the editing electronic device 1 or the storage medium 36. The storage medium 36 may be Youtube, Tudou, Youku or PPS that is a video-sharing platform accessible via the network 4. In this embodiment, the property field set 320 of the electronic setup page includes an editable first information field set 321 associated with the primary media content 51 to identify the primary media content 51, an editable second information field set 322 associated with the secondary media content 52 to identify the secondary media content 52 and to define time point of presenting the secondary media content 52 during reproduction of the primary media content 51, and a preview player interface 323 for reproducing the primary media content 51. In detail, the first information field set 321 may include at least one of a file path field, a serial code field, a genre field, a title field, an abstract field, and a keyword field. The second information field set 322 may include at least one of a file path field, a time point field, a product name field, a product introduction field, a product price field, a product ingredient field, and a product quantity field. The setup data is received by the publishing system via the electronic setup page.

Through the electronic setup page, the secondary media content 52 having the predefined correspondence with the primary media content 51 may be set to be displayed at a specified time point during reproduction of the primary media content. 51. For example, if an advertisement of a dress (secondary media content 52) is intended to be presented at the eighth second of reproduction of the primary media content 51, the file path at which the advertisement of the dress is located (e.g., “D:\*.*” shown in FIG. 4) is inputted in one slot of the second information field set 322, and the time point (e.g., “00:08” shown in FIG. 4) at which the advertisement of the dress is intended to be presented is inputted in another slot of the second information field set. 322 that corresponds to the advertisement of the dress.

The layout setting module 33 sets the layout of the composite media content. 5 according to the setup data inputted in an editable layout field set 330 of the electronic setup page. The layout field set 330 is used to define relative display positions of the primary media content ha when reproduced by the client electronic device 3 and the secondary media content. 52 when presented by the client electronic device 3. For example, the primary media content 51 and the secondary media content 52 may be set to be displayed in a horizontal or a vertical arrangement as desired by the layout setting module 33 according to the setup data.

In addition, when the secondary media content 52 includes individual media contents, the manner of display of the individual media contents may be set in the electronic setup page, and the layout setting module 33 may arrange the display manner accordingly. For example, each of the individual media contents has a specified time point during reproduction of the primary media content 51 that has been defined in the second information field set 322. In one embodiment, the individual media contents are presented sequentially in a form of thumbnails according to the respective predefined time points. In another embodiment, the individual media contents are presented in sequence according to the respective predefined time points, and only one of the individual media contents is presented at a time.

The authorization module 34 sets authorization condition of the composite media content 5 according to the setup data inputted in an editable authorization field set 340 in the electronic setup page. The authorization field set 340 may include a searchable authorization, a privacy authorization, or a messaging authorization, where the searchable authorization is used to determine whether the composite media content 5 is searchable by search engines, the privacy authorization is used to determine whether composite media content 5 is hidden, and the messaging authorization is used to determine whether viewers may leave comments or messages with the composite media content 5. In one embodiment, the authorization field set 340 may include a user account and password. The publishing system determines to which electronic device ownership of the composite media content 5 belongs according to a certification affiliated with the user account and the password.

The processing module 35 generates the webpage data by merging the primary media content 51 and the secondary media content 52 according to data in the editable layout field set 331 for the setup data that is associated with the primary media content 51 and the secondary media content 52 for presentation of the composite media content 5. In detail, the processing module 35 generates a composite media content item by merging the primary media content item and the secondary media content item(s) based upon the setup data, and generates the webpage data accordingly.

The webpage data includes a primary media presentation interface and secondary media presentation interface. The primary media presentation interface includes program instructions that configure the client electronic device 3 to reproduce the primary media content 51 from the composite media content item. The secondary media presentation interface includes program instructions that configure the client electronic device 3 to present the secondary media content(s) 52 from the composite media content item. It should be noted that, the program instructions of the secondary media presentation interface further configure the client electronic device 3 to present the secondary media content 52 when the time point defined in the setup data is reached during reproduction of the primary media content 51 by the client electronic device 3.

The storage medium 3u is adapted for storing the composite media content item. In this embodiment, the storage medium 36 employs cloud storage techniques.

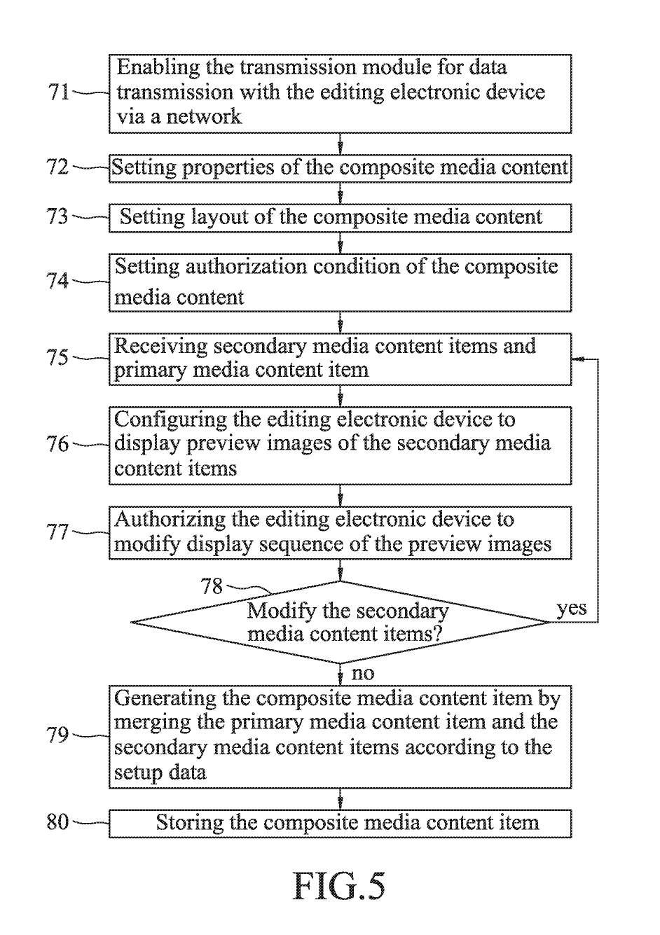

FIG. 5 is a flow chart illustrating steps of preparation for publishing the composite media content. 5.

Step 71: The transmission module 31 is enabled for data transmission with the editing electronic device 1 via the network 4 (see FIG. 2). In detail, the transmission module 31 provides the electronic setup page generated by the publishing system to the editing electronic device 1, and receives the setup data inputted via the electronic setup page. The electronic setup page may be generated using a network application that is embedded into a webpage accessed by the editing electronic device 1.

Step 72: The editing module 32 sets the properties of the composite media content 5 according to the setup data inputted in the editable property field set 320 of the electronic setup page.

Step 73: The layout setting module 33 sets the layout of the composite media content 5 according to the setup data inputted in the editable layout field set 330 of the electronic setup page.

Step 74: The authorization module 34 sets the authorization condition of the composite media content 5 according to the setup data inputted in the editable authorization field set 340 in the electronic setup page.

Step 75: The transmission module 31 receives the secondary media content item (s) according to the file path (s) inputted in the second information field set 322. In one embodiment, the transmission module 31 also receives the primary media content item according to the file path inputted in the first information field set 321.

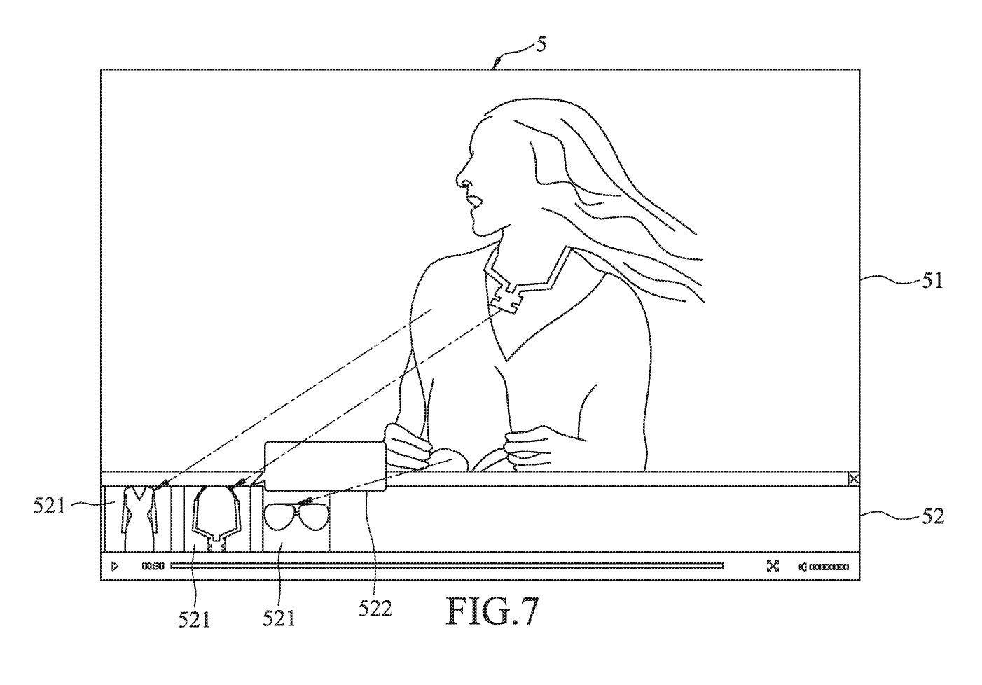

Step 76: The processing module 35 configures the editing electronic device 1 to display preview images of the secondary media content items in sequence according to the time points inputted in the second information field set 322. In this embodiment, the preview images of the secondary media content items are image content 521 included in the secondary media content 52 (see FIGS. 2 and 7).

Step 77: The processing module 35 authorizes the editing electronic device 1 to modify display sequence of the preview images of the secondary media content items during reproduction of the primary media content 51. In this embodiment, positions of the preview images shown on the editing electronic device 1 may be directly moved by the content provider for modifying the display sequence of the preview images of the secondary media content items.

Step 78: The processing module 33 confirms through the electronic setup page whether modification of the secondary media content items (e.g., add more items into the secondary media content items, or delete item from the secondary media content items) is required. The flow goes to step 75 when the modification is required, and goes to step 79 when otherwise.

Step 79: The processing module 35 generates the composite media content item by merging the primary media content item and the secondary media content items according to the setup data associated with the primary media content 51 and the secondary media content 52. In this embodiment, the setup data includes the display sequence determined in step 77, the authorization condition set in step 74, the layout set in step 73 and the properties set in step 72.

Step 80: The storage medium 36 stores the composite media content item.

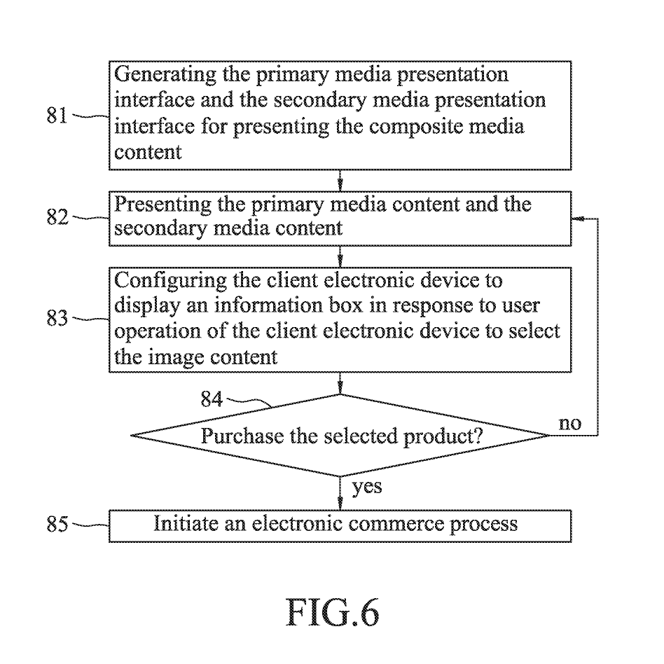

FIG. 6 is a flow chart illustrating steps of presenting the composite media content 5.

Step 81: The processing module 35 generates the primary media presentation interface and the secondary media presentation interface for connecting the client electronic device 3 to the storage medium 36 for presenting the composite media content 5 using the composite media content item.

Step 82: The processing module 35 presents the primary media content 51 using the primary media presentation interface and presents the secondary media content 52 using the secondary media presentation interface in response to a request from the client electronic device 3. In this embodiment, the secondary media content 52 includes the preview images of the secondary media content items in the form of thumbnails.

It should be noted that the preview images are presented at specified time points in the display manner set in step 73 during reproduction of the primary media content 51, In the example, when the primary media content 51 is being presented, an actress wearing a dress walks out of a door at the eighth second, the actress takes off her glasses at the twenty-first second, and a close-up shot of the actress with a necklace is presented at the thirtieth second. Accordingly, the preview images of the dress, the glasses and the necklace are set to be presented at the eighth second, the twenty-first second, and the thirtieth second, respectively. In one embodiment, the secondary media content 52 shows only the preview image of the dress at the eighth second, only the preview image of the glasses at the twenty-first second, and only the preview image of the necklace at the thirtieth second. In another embodiment, the secondary media content 52 shows the preview image of the dress at the eighth second, both of the preview images of the dress and the glasses at the twenty-first second, and the preview images of the dress, the glasses and the necklace at the thirtieth second.

Step 83: The processing module 35 configures the client electronic device 3 to display, in response to user operation of the client electronic device 3 to select the image content (e.g., using a mouse or a touch panel to select one of the preview images of the secondary media content items), an information box containing the corresponding one of the secondary media content items and a button. The information box may be presented in a form of a remark frame or a browser window. In one embodiment, the primary media presentation interface includes instructions to pause reproduction of the primary media content 51 when the client electronic device 3 is configured to display the information box, so that the viewer may not miss experiencing the primary media content 51 when reading the content shown in the information box. In one embodiment, the processing module 35 configures the client electronic device 3 to open a browser window to access a webpage defined in the setup data. Through such a design, the viewer may read detailed information of the product which he or she is interested in.

Step 84: The processing module 35 confirms with the viewer whether the viewer is interested in purchasing the product selected in step 83 via the button contained in the information box. In response to an affirmative confirmation from the viewer, the flow goes to step 85. Otherwise, the processing module 35 closes toe information box, and the flow goes back to step 82.

Step 85: The processing module 35 initiates an electronic commerce process for enabling the viewer to purchase the product selected in step 83. Accordingly, the viewer may enjoy not only watching videos but also shopping at the same time. When the viewer sees an attractive product appearing in the primary media content 51, he or she may immediately read details of product information from the secondary media content and purchase the product in the subsequent e-commerce process using the present invention.

The method of publishing composite media content and the publishing system according to the present invention have the following advantages:

1. When the viewer sees an attractive product appearing in the primary media content 51, he or she may immediately read details of product information from the secondary media content 52, and purchase the product through the subsequent e-commerce process, to thereby enhance effectiveness of placement marketing.

2. The content provider may edit layout of the primary media content 51 and the secondary media content 52, so as to enhance viewing experience when watching the composite media content 5.

3. The content provider may easily produce the composite media content. 5 by inputting setup data via the electronic setup page without downloading or installing editing tools in the editing electronic device 1.

The viewer may immediately get more information about objects appearing in the primary media content 51. Such feature may broaden application fields of the present invention. For example, the present invention is also suitable for use in business, presentation, teaching, etc.

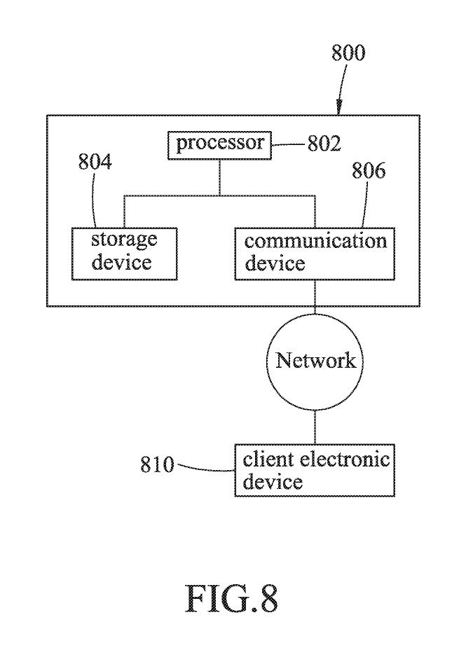

FIG. 8 is a block diagram illustrating a host server 800 for implementing a method for creating a composite media file, according to one embodiment of the disclosure.

In this embodiment, the term “composite media file” refers to a media file that incorporates elements from a primary media file (e.g., a video file) and a secondary media file (e.g., an image file). During the playing of the composite media file, the secondary media file may be displayed at a specific time instance.

The host server 800 includes a processor 802, a storage device 804, and a communication device 806. When a user intends to obtain the composite media file, he/she may operate a client electronic device 810 that communicates with the communication device 806 of the host server 800 over a network (e.g., the Internet). Specifically, the client electronic device 810 may be operated to access a website directed to the host server 800.

The host server 800 may require the user of the client, electronic device 810 to complete an authentication operation (e.g., a “login” operation) in order to be allowed to interact with the host server 800 for obtaining the composite media file.

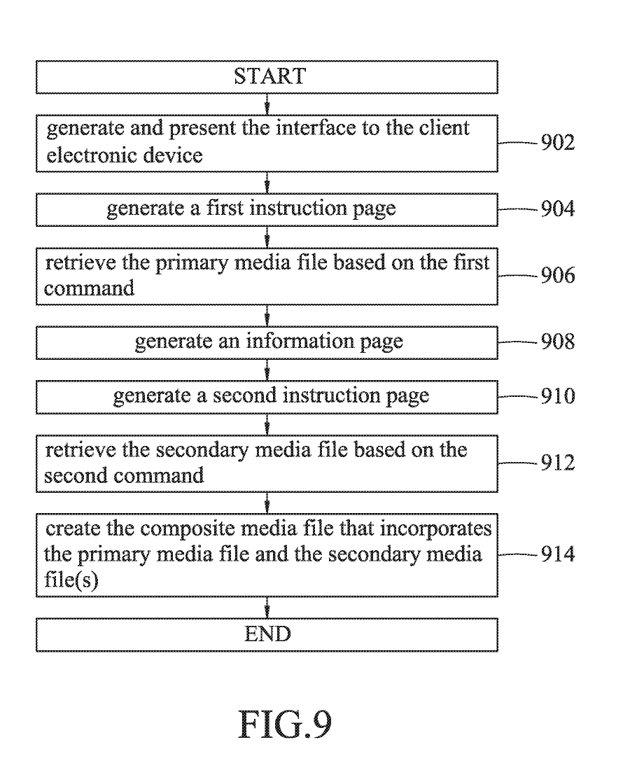

FIG. 9 is a flow chart illustrating steps of the method for creating the composite media file, according to one embodiment of the disclosure.

In step 902, the processor 802 of the host server 800 generates an interface, and presents the interface to the client electronic device 810. Specifically, the interface may be in the form of a setup page that is generated after the authentication operation is completed, and subsequently displayed on the client electronic device 810. In one example, the setup page may be generated using HyperText Markup Language 5 (HTML5).

In step 904, the processor 802 generates a first instruction page to instruct the user to provide a first command directed to the primary media file, which in this embodiment is a video file.

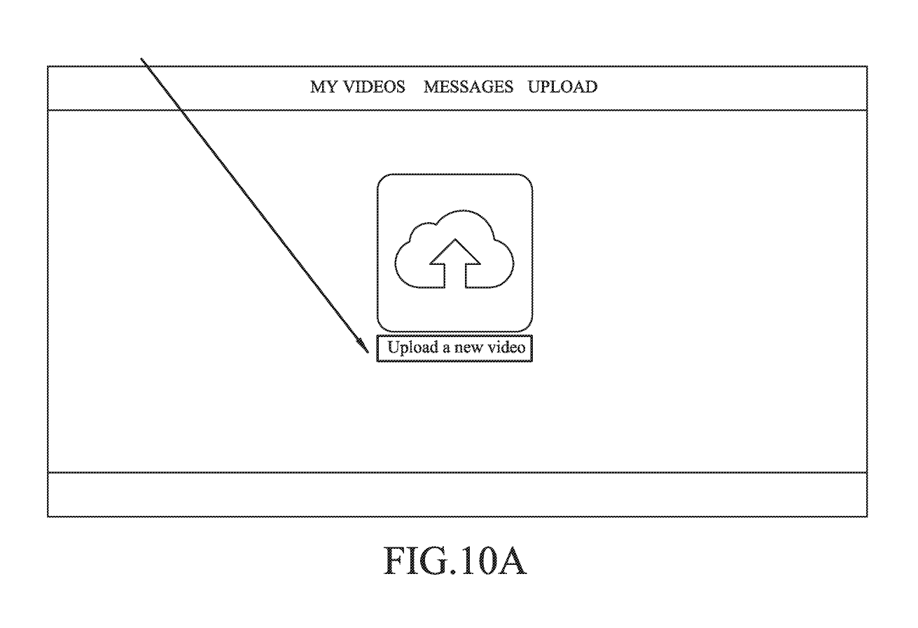

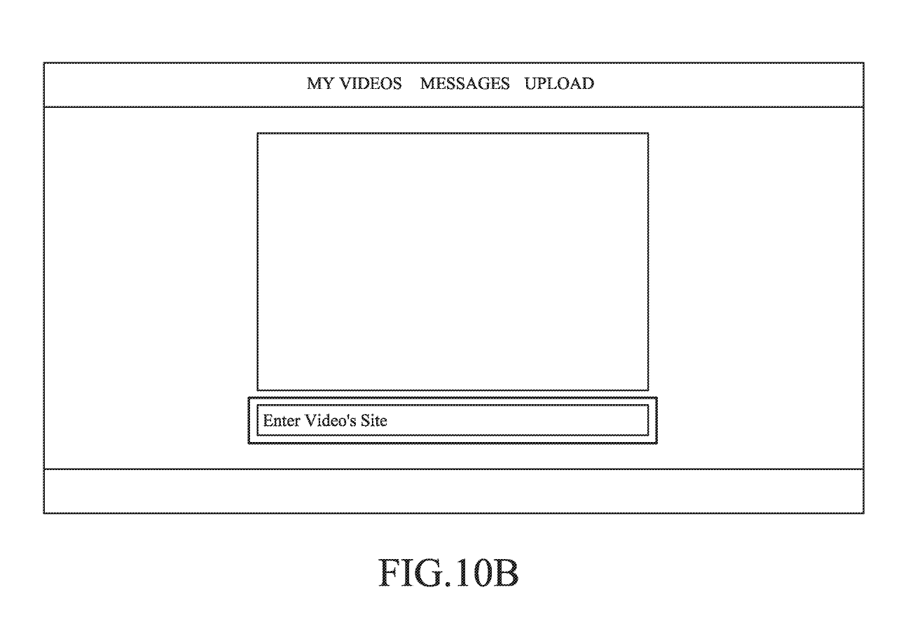

In one example, the instruction may ask the user to “upload a new video” (see FIG. 10A). In turn, the user may select a video file stored in the client electronic device 810 and operate the client electronic device 810 to transmit the first command along with the video file to the host server 800.

In another example, the instruction may ask the user to provide a video link directed to a party (e.g., a website) that contains the video file (see FIG. 10B). In response to receipt of the video link, the processor 802 is programmed to access the party containing the video file.

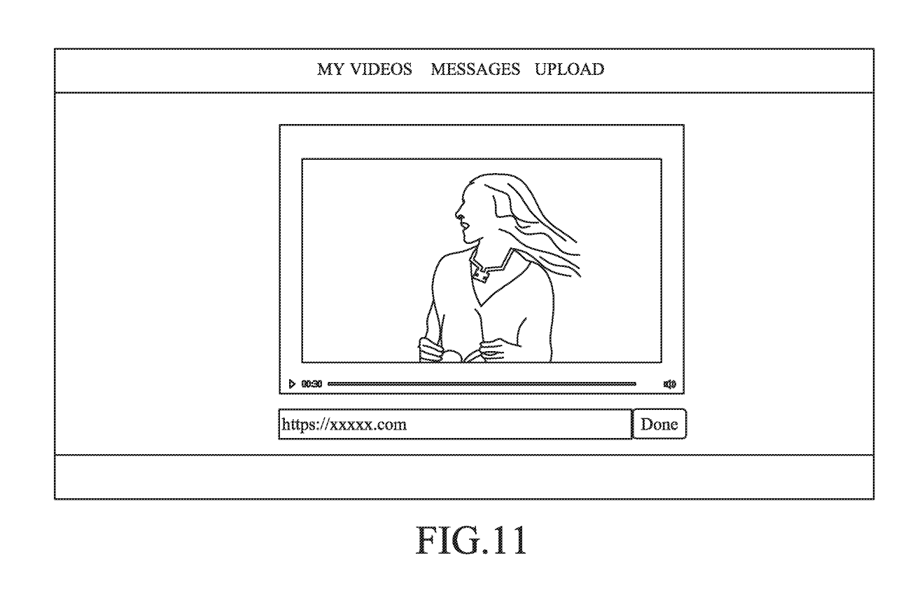

In step 906, the processor 802 retrieves the primary media file based on the first command. That is to say, the processor 802 is programmed to retrieve the primary media file which may be directly transmitted to the host server 800, or may alternatively be provided by the user using the video link. In one example as shown in FIG. 11, the primary media file is a commercial video provided using video link and subsequently retrieved by the processor 802.

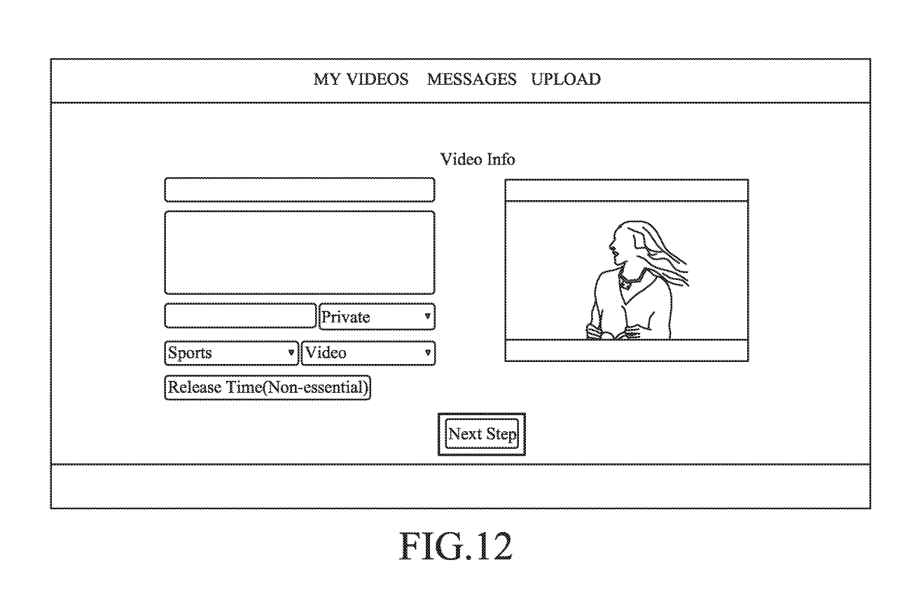

In step 908, the processor 802 generates an information page for allowing the user of the client electronic device 810 to input relevant information regarding the primary media file. FIGS. 4 and 12 illustrate exemplary information pages generated by the processor 802.

In step 910, the processor 802 generates a second instruction page to instruct the user to provide a second command directed to the secondary media file via the interface.

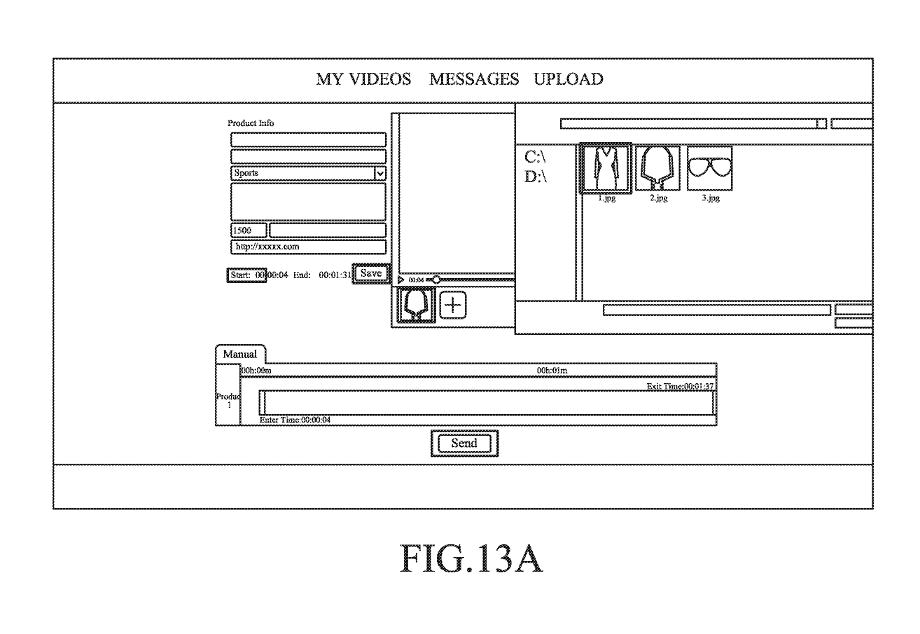

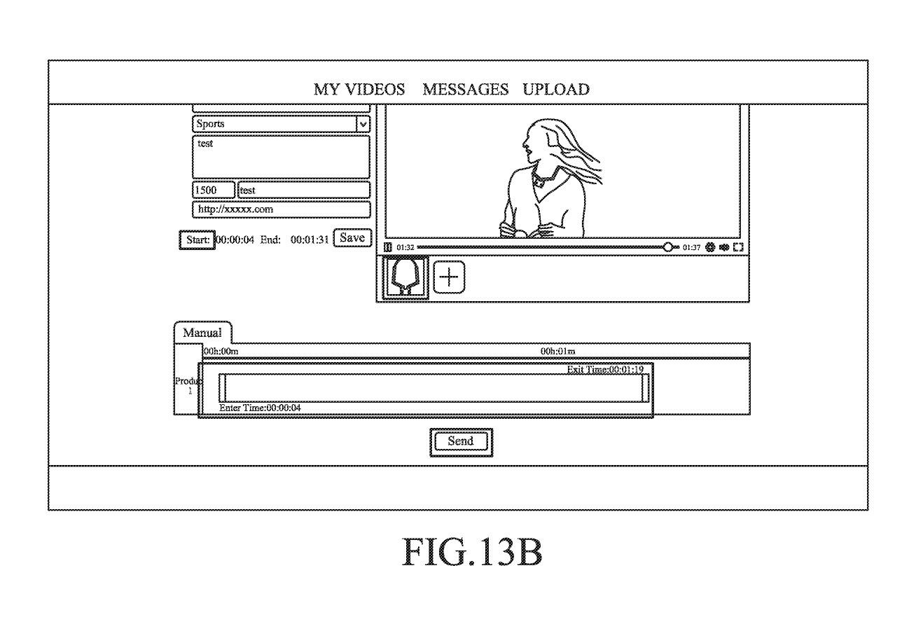

FIG. 13A illustrates an exemplary second instruction page. In use, the user may click a plus sign button on the second instruction page in order to transmit a media file, serving as the secondary media file, to the host server 800.

In response to the clicking of the plus sign button, the user is instructed to select, a media file stored in the client electronic device 810 for transmission. In this embodiment, an image file (e.g., one in the Joint Photographic Experts Group (JPEG) format) is selected. After the media file serving as the secondary media file is transmitted to the host server 800, the user is allowed to select, for the secondary media file, a designated enter time instance and a designated exit time instance associated with the playing of the primary media file.

The designated enter time instance indicates when the secondary media file should be displayed with respect to the playing of the primary media file. The designated exit time instance indicates when the secondary media file should cease to be displayed with respect to the playing of the primary media file.

For example, as shown in FIG. 13B, the designated enter time instance is set as 00:00:03, and the designated exit time instance is set as 00:01:19. That is to say, it is intended for the secondary media file to be displayed between the 3^{rd} second and the 79^{th} second of the playing of the primary media file.

In step 912, the processor 802 retrieves the secondary media file based on the second command.

In some embodiments, steps 910 and 912 may be repeated in case that the user intends to incorporate multiple secondary media files with the same primary media file. It is noted that in such cases, each of the retrieved secondary media files is associated with a specific set of designated enter time instance and designated exit time instance.

In step 914, the processor 802 creates the composite media file that incorporates the primary media file and the secondary media file(s).

It is noted that the composite media file is thus created such that when the composite media file is played by a media playing device, the secondary media file is displayed simultaneously with and separately from the primary media file on a screen of the media playing device at the designated enter time instance, and is not displayed after the designated exit time instance. In the case that a plurality of secondary media files are incorporated, the composite media file may be created such that only one of the plurality of the secondary media files is displayed at a time. Alternatively, in case where there is an overlap between the display time (time interval between the designated enter time instance and designated exit time instance) of one secondary media file and the display time of another secondary media file, these two secondary media files may be simultaneously displayed along with the primary media file during the overlapping time.

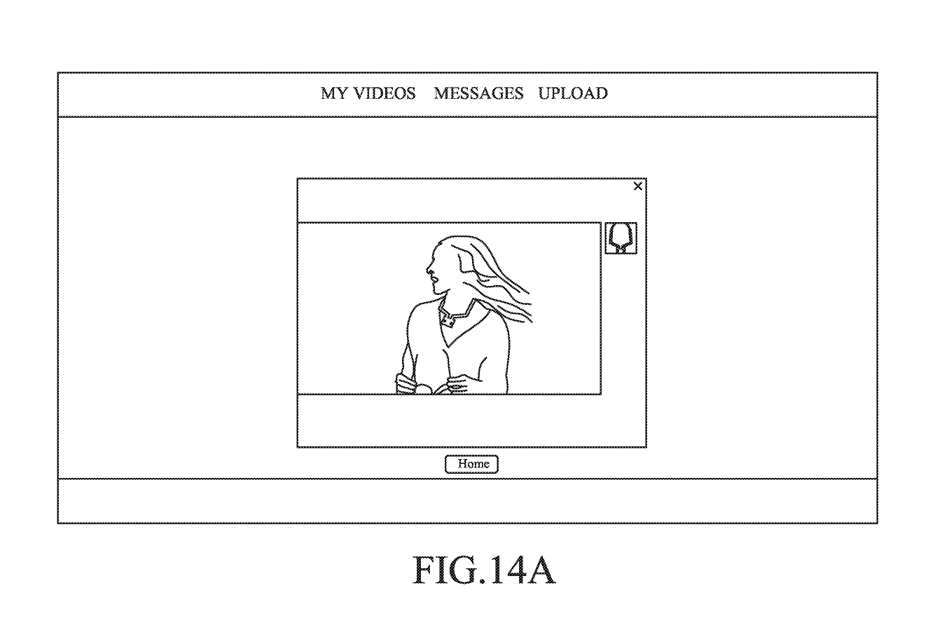

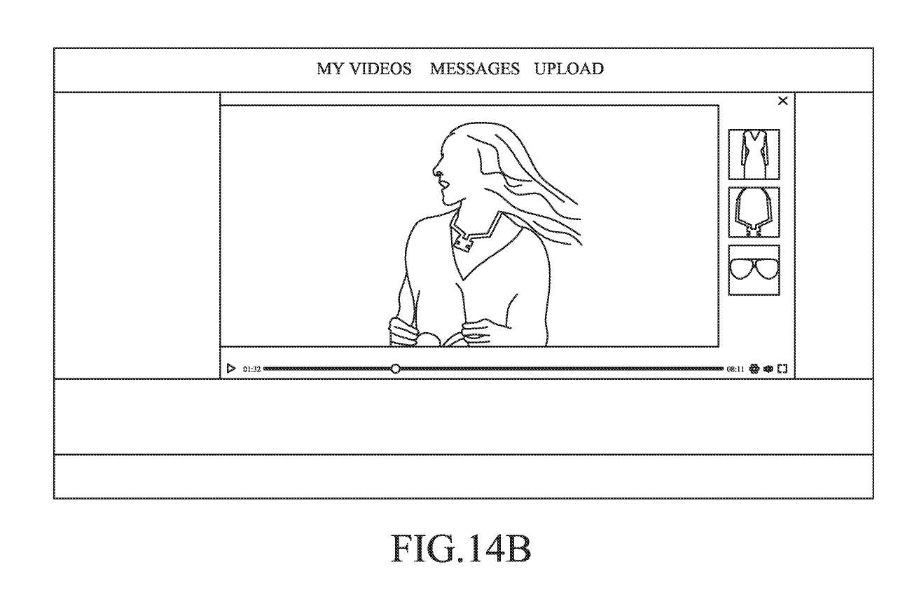

FIG. 14A illustrates a preview page of the completed composite media file. In this embodiment, the processor 802 is further programmed to upload the composite media file to a cloud server to be stored therein, to generate a link directed to the stored composite media file, and to provide the link to the client electronic device 810. Using the provided link, a party (e.g., another user) is allowed to access the composite media file.

In one embodiment, the processor 802 is further programmed to provide a share option for allowing the party to publish the link on a platform.

As shown in FIG. 14B, the completed composite media file uploaded onto the video sharing site YouTube, and is embedded into a website provided by the host server 800. The website includes buttons that allows a viewer to share the composite media file to other platforms such as Facebook.

In one embodiment, the secondary media file includes an image and an associated link directed to a predefined webpage that is associated with an object appearing in the image. The composite media file is created in a manner that the image appears on the screen with a button which, in response to a user selection, controls the media playing device to open a browser window to access the predefined webpage.

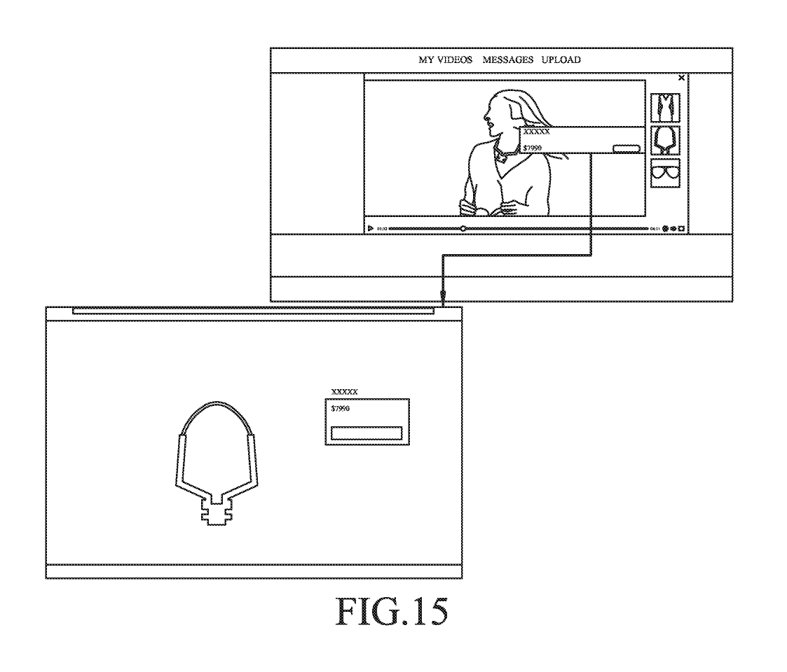

FIG. 15 illustrates such an embodiment, in which one of the images showing a ring is selected and then a button for opening a corresponding website is clicked. In response, the predefined webpage offering the ring for sale is opened in the browser window.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for creating a composite media file, the method being implemented by a processor included in a host server and comprising the steps of:
generating an interface and presenting the interface to a client electronic device that communicates with the host server;
receiving a first command directed to a primary media file via the interface, the primary media file being a video file;
retrieving the primary media file based on the first comma rid;
receiving a second command directed to a secondary media file via the interface, the second command including at least one designated time instance associated with playing of the primary media file;
retrieving the secondary media file based on the second command; and
creating a composite media file that incorporates the primary media file and the secondary media file;
wherein, the processor is programmed to create the composite media file in such a manner that when the composite media file is played by a media playing device, the secondary media file is displayed simultaneously with and separately with respect to the primary media file on a screen of the media playing device at the designated time instance.

2. The method of claim 1, further comprising, after creating the composite media file, the steps of:
uploading the composite media file to a cloud server to be stored therein; and
generating a link directed to the stored composite media file and providing the link to the client electronic device, the link allowing a party to access the composite media file.

3. The method of claim 2, further comprising, after generating the link, the step of providing at least one share option for allowing the party to publish the link on a platform.

4. The method of claim 1, wherein:
the second command is directed to a plurality of secondary media files and includes a plurality of designated time instances, each of the plurality of secondary media files corresponding to at least one of the designated time instances;
the processor retrieves the plurality of secondary media files based on the second command; and
the processor is programmed to create the composite media file in a manner that when the composite media file is played by a media playing device, each of the plurality of the secondary media files is displayed simultaneously with and separately with respect to the primary media file on the screen of the media playing device at a corresponding one of the designated time instances.

5. The method of claim 4, wherein only one of the plurality of the secondary media files is displayed at a time.

6. The method of claim 1, wherein:
the secondary media file includes an image and an associated link directed to a predefined webpage associated with an object appearing in the image; and
the processor is programmed to create the composite media file in such a manner that the image appears on the screen with a button which, in response to user selection, controls the media playing device to open a browser window to access the predefined webpage.

7. The method of claim 1, further comprising the step of:
receiving setup data for defining relative positions of the primary media file and the secondary media file when the composite media file is played by the media playing device.

8. The method of claim 1, wherein the first command is directed to a party containing a video file to be served as the primary media file.

9. The method of claim 1, wherein the first command is transmitted to the host server along with the primary media file.

10. The method of claim 1, wherein:
the second command includes a designated enter time instance and a designated exit time instance associated with the playing of the primary media file; and
the processor is programmed to create the composite media file in such a manner that when the composite media file is played by a media playing device, the secondary media file is displayed simultaneously with and separately with respect to the primary media file on a screen of the media playing device at the designated enter time instance, and to disappear at the designated exit time instance.

11. A host server for creating a composite media file, comprising a processor and a communication device, wherein said processor is programmed to implement the steps of:
generating an interface and presenting the interface to a client electronic device that communicates with the host server;
receiving a first command directed to a primary media file via the interface, the primary media file being a video file;
retrieving the primary media file based on the first command;
receiving a second command directed to a secondary media file via the interface, the second command including at least one designated time instance associated with playing of the primary media file;
retrieving the secondary media file based on the second command; and
creating a composite media file that incorporates the primary media file and the secondary media file;
wherein, said processor is programmed to create the composite media file in such a manner that when the composite media file is played by a media playing device, the secondary media file is displayed simultaneously with and separately with respect to the primary media file on a screen of the media playing device at the designated time instance.
